(19) United States
(12) Patent Application Publication
(10) Pub. No.: US 2015/0238840 A1
(43) Pub. Date: Aug. 27, 2015

(54) GOLF NAVIGATION TERMINAL AND GOLF NAVIGATION DEVICE USING SAME

(71) Applicants: RUBY CO., LTD., Wanju (KR); INDUSTRY ACADEMIC COOPERATION FOUNDATION OF WOOSUK UNIVERSITY, Wanju (KR)

(72) Inventors: Eun-Ey Jung, Paju (KR); Hong Ki Lee, Jeonju (KR)

(73) Assignees: RUBY CO., LTD., Wanju (KR); INDUSTRY ACADEMIC COOPERATION FOUNDATION OF WOOSUK UNIVERSITY, Wanju (KR)

(21) Appl. No.: 14/427,079

(22) PCT Filed: Sep. 13, 2013
(86) PCT No.: PCT/KR2013/008288

§ 371 Date: Mar. 10, 2015

(30) Foreign Application Priority Data
Sep. 17, 2012 (KR) 10-2012-0103029

(51) Int. Cl. A63B 71/06; A63B 69/36; G06F 3/0482; G06F 3/0488; G06F 3/0484

(52) U.S. Cl. CPC A63B 71/0669; G06F 3/04886; G06F 3/04842; G06F 3/04847; G06F 3/0482; A63B 69/36; A63B 2069/3602

(57) ABSTRACT

The present invention relates to a golf navigation terminal and a golf navigation device using the same. One of the things people always care about when playing golf is scorekeeping. The present invention automatically calculates a score so that a golf player can concentrate on his or her play. When the golf player plays a game, while wearing the golf navigation terminal of the present invention on the waist, the golf navigation terminal automatically detects how the player is doing and sends this to the golf navigation device, and the golf navigation device then calculates the player's score. Afterwards, the score is wirelessly communicated to the golf navigation terminal. The score is fixed after the player's confirmation or correction. According to the present invention, the player may view his or her score from time to time, either through a display on the golf navigation terminal or on the golf navigation device.

### TECHNICAL FIELD

The present invention relates to a golf navigation terminal and a golf navigation device using the same, and more particularly, to a golf navigation terminal which displays a golfer's path or calculates a golf score and reports it, and a golf navigation device using the same.

### BACKGROUND ART

Many people enjoy various sports for health reasons.

Among them, golf is one of the most widely played sports worldwide.

Golf has its own scoring rules, and players can keep their own score or caddies can.

It could be troublesome for the players to keep their score, or sometimes they may do it wrong.

Moreover, it is important for a player to focus on his or her stance or game, and the player may not play well if he or she cares about scorekeeping.

Nevertheless, there is currently no automatic golf scoring equipment.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide a golf navigation terminal which automatically calculates a golfer's score and reports it in a golf game, and a golf navigation device using the same.

### Technical Solution

Furthermore, the present invention provides a golf navigation device which displays a golfer's path on a golf course.

An exemplary embodiment of the present invention provides a golf navigation terminal which detects a movement of a player playing with a golf club and communicates with a golf navigation device, the golf navigation terminal including:

a display panel for receiving a user's selection or displaying data;

a motion detector for detecting data about the player's position, movement, and motion or about a golf ball's position;

a terminal communication part for communicating with the golf navigation device; and

a terminal controller that receives output from the motion detector and transmits the output to the golf navigation device via the terminal communication part, displays the player's score on the display panel upon receiving from the golf navigation device, and when the player enters confirmation data or corrected data, transmits the confirmation data or the corrected data to the golf navigation device.

The motion detector may include at least one of:

a GPS receiver that receives a signal from a GPS satellite and calculates and outputs the GPS receiver's location;

a vibration sensor for sensing a vibration produced when the player moves or hits a golf ball with a golf club;

a light sensor for sensing a change in the amount of light caused by the player's hand movement;

a magnetic sensor for sensing movements of metal parts of the golf club used by the player; and

a sound sensor for sensing a sound produced when the player hits a golf ball or a sound produced when the golf ball rolls into a hole.

The terminal controller may receive output from the GPS receiver, the vibration sensor, the light sensor, the magnetic sensor, and the sound sensor, and transmit the output to the golf navigation device via the terminal communication part, display the player's score on the display panel upon receiving it from the golf navigation device, and when the player enters confirmation data or corrected data, transmit the confirmation data or the corrected data to the golf navigation device.

The display panel may include: a display for displaying data; a menu button switch for selecting menu options; a confirmation button switch for confirming data input; an up button switch for raising the score one level; and a down button switch for lowering the score one level.

The golf navigation terminal may include: a power supply part for supplying power to the display panel, the terminal communication part, the controller, and the motion detector; and a power switch for selecting whether to supply power or not.

The navigation golf terminal may further include: a memory for storing data received by the motion detector and the confirmation data or corrected data; a communication port for transmitting and receiving data in the memory to and from the outside world; and a charging terminal for charging the power supply part.

Another exemplary embodiment of the present invention provides a golf navigation terminal which detects a movement of a player playing with a golf club and communicates with a golf navigation device, the golf navigation terminal including: a display panel for receiving a user's selection or displaying data; a motion detector for detecting data about the player's position, movement, and motion or about a golf ball's position; a terminal communication part for communicating with the golf navigation device; and a terminal controller that receives an output from the motion detector, creates a score based on data about the player's position, movement, and motion or about a golf ball's position and displays the score on the display panel, and when the player enters confirmation data or corrected data, transmits the confirmation data or the corrected data to the golf navigation device.

Yet another exemplary embodiment of the present invention provides a golf navigation device which communicates with a golf navigation terminal, the golf navigation device including: a touch screen for receiving a user's selection; a display for displaying data; a communication part for communicating with the golf navigation terminal; and a controller that receives data about the player's position, movement, and motion or about a golf ball's position, creates a score corresponding to the received data and transmits the score to the golf navigation terminal via the communication part, and upon receiving confirmation data or a corrected score from the golf navigation terminal, displays the received confirmation data or corrected score on the display.

The controller may create a score when the player moves or hits a golf ball with a golf club or when the golf ball rolls into a hole.

The golf navigation device may further include a memory for storing data,

wherein the controller may cumulatively store the score in the memory.

The golf navigation device may further include: a power supply part for supplying power to the touch screen, the display, the communication part, and the controller; and a power switch for selecting whether to supply power or not.

The golf navigation device may further include: a communication port for transmitting and receiving data in the memory to and from the outside world; and a charging terminal for charging the power supply part.

The memory additionally stores map data of the golf course, and the controller creates a score with additional reference to the map data of the golf course.

### Advantageous Effects

According to an embodiment of the present invention, the present invention aims to solve the drawbacks occurring in the related art, and provides a golf navigation terminal which displays a golfer's path or automatically calculates a golf score and reports it, and a golf navigation device using the same.

Furthermore, the present invention provides a golf navigation device which displays a golfer's path on a golf course.

### Description of the Drawings

FIG. 1 is a block diagram of a golf navigation terminal according to an exemplary embodiment of the present invention.

FIG. 2 is a detailed block diagram of the display panel of FIG. 1.

FIG. 3 is a block diagram of a golf navigation device according to an exemplary embodiment of the present invention.

FIG. 4 shows communication between the golf navigation terminal and the golf navigation device according to an exemplary embodiment of the present invention.

FIG. 5 is a view showing communication between the golf navigation terminal and a smartphone according to an exemplary embodiment of the present invention.

FIG. 6 is a view showing communication between the golf navigation device and a server according to an exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation, and can be implemented by hardware components or software components and combinations thereof.

As a rule, an exemplary embodiment of the present invention will be described focusing on a golf navigation terminal 100 and a golf navigation device 200. The golf navigation terminal 100 and the golf navigation device 200 communicate wirelessly with each other to send and receive data.

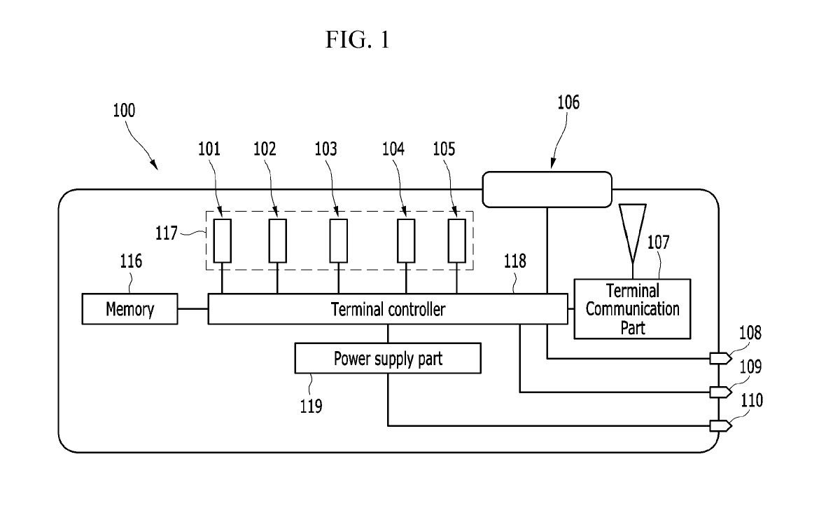

FIG. 1 is a block diagram of a golf navigation terminal according to an exemplary embodiment of the present invention.

Referring to FIG. 1, the golf navigation terminal 100 according to an exemplary embodiment of the present invention detects a movement of a player playing with a golf club and communicates with the golf navigation device 200.

The golf navigation terminal 100 includes: a display panel 106 for receiving a user's selection or displaying data; a motion detector 117 for detecting data about the player's position, movement, and motion or about a golf ball's position; a terminal communication part 107 for communicating with the golf navigation device; and a terminal controller 118 that receives an output from the motion detector 117 and transmits the output to the golf navigation device via the terminal communication part 107, displays the player's score on the display panel 106 upon receiving it from the golf navigation device 200, and when the player enters confirmation data or corrected data, transmits the confirmation data or the corrected data to the golf navigation device 200.

If necessary, the golf navigation terminal 100 includes: a power supply part 119 for supplying power to each part of the golf navigation terminal 100; a power switch 108 for selecting whether to supply power or not; a memory 116 for storing data received by the motion detector and the confirmation data or corrected data; a communication port 109 for transmitting and receiving data in the memory 116 to and from the outside world; and a charging terminal 110 for charging the power supply part 119.

The motion detector 117 includes at least one of: a GPS receiver 101 that receives a signal from a GPS satellite and calculates and outputs the GPS receiver's location; a vibration sensor 102 for sensing a vibration produced when the player moves or hits a golf ball with a golf club; a light sensor 103 for sensing a change in the amount of light caused by the player's hand movement; a magnetic sensor 104 for sensing movements of metal parts of the golf club used by the player; and a sound sensor 105 for sensing a sound produced when the player hits a golf ball or a sound produced when the golf ball rolls into a hole.

The terminal controller 110 may be realized by a microcontroller. The terminal controller 110 receives output from the GPS receiver 101, the vibration sensor 102, the light sensor 103, the magnetic sensor 104, and the sound sensor 105 and transmits the output to the golf navigation device via the terminal communication part 107, displays the player's score on the display panel upon receiving it from the golf navigation device, and when the player enters confirmation data or corrected data, transmits the confirmation data or the corrected data to the golf navigation device.

As shown in FIG. 1, the golf navigation terminal 100 is configured to monitor the player's position and motion in real time by using the GPS receiver 101, the vibration sensor 102, the light sensor 103, the magnetic sensor 104, and the sound sensor 105. The golf navigation terminal 100 is equipped with the memory 116 capable of storing data processed by the microcontroller-based terminal controller 118 to communicate wirelessly with the outside world via an RF module type of terminal communication part 107 as necessary.

The golf navigation terminal 100 is portable, the power supply part 119 is implemented as a charging battery, and the charging terminal 110 for charging the battery is on the outside.

Moreover, the golf navigation terminal 100 is equipped with the communication port 109 capable of downloading data stored in the memory 116 or data being processed within it, so that scores on the golf navigation terminal 100 can be seen on or stored in an external PC, etc.

Furthermore, the golf navigation terminal 100 is equipped with the power switch 108 to save the battery when not in use by turning off the power switch 108.

In addition, the golf navigation terminal 100 is equipped with the display panel 106 to enable the player to confirm or correct his or her score.

The display panel 106 will be described in detail.

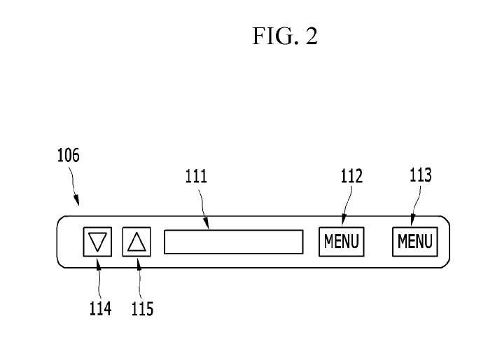

Referring to FIG. 2, the display panel 106 includes a display 111 for displaying data, a menu button switch 112 for selecting menu options, a confirmation button switch 113 for confirming data input, an up button switch 114 for raising the score one level, and a down button switch 115 for lowering the score one level.

The display panel 106 may be installed on the side of the golf navigation terminal 100, and may be equipped with the display 111, the menu button switch 112, the data input confirmation button switch 113, the up button switch 114, and the down button switch 115 so that the player can read data he or she needs or correct scores or data by operating the button switches 112 to 115.

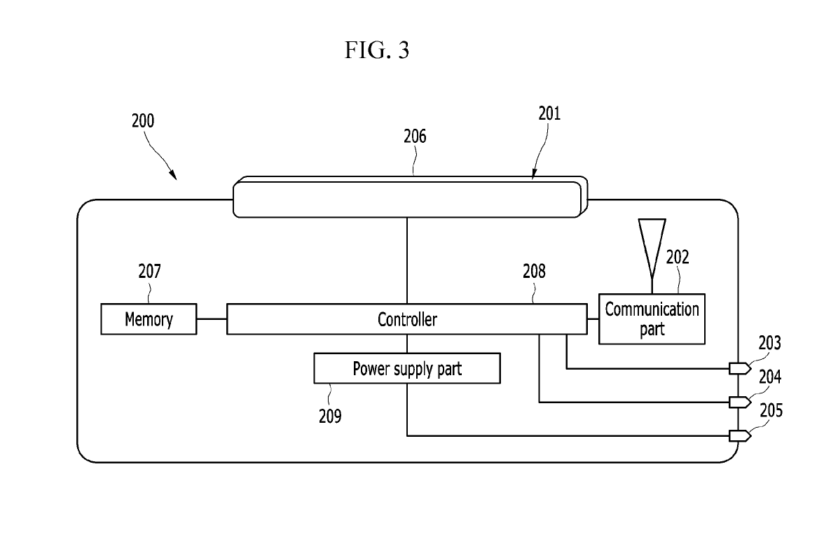

FIG. 3 is a block diagram of a golf navigation device according to an exemplary embodiment of the present invention.

Referring to FIG. 3, a golf navigation device which communicates with a golf navigation terminal according to an exemplary embodiment of the present invention communicates with a golf navigation terminal.

The golf navigation device includes: a touch screen 201 for receiving a user's selection; a display 206 for displaying data; a communication part 202 for communicating with the golf navigation terminal 100; and a controller 208 that receives data about the player's position, movement, and motion or about a golf ball's position, creates a score corresponding to the received data and transmits the score to the golf navigation terminal 100 via the communication part 202, and upon receiving confirmation data or a corrected score from the golf navigation terminal 100, displays the received confirmation data or corrected score on the display 206.

The controller 208 creates a score when the player moves or hits a golf ball with a golf club or when the golf ball rolls into a hole. For example, the controller 208 creates a score by determining how many strokes the player has taken to hole out. The score can be expressed as the number of strokes or in other ways.

The golf navigation device 200 may further include a memory 207 for storing data, and the controller 208 may cumulatively store the score in the memory.

The golf navigation device 200 further includes a power supply part 209 for supplying power to each part of the golf navigation device 200, a power switch 203 for selecting whether to supply power or not, a communication port 204 for transmitting and receiving data in the memory 207 to and from the outside world, and a charging terminal 205 for charging the power supply part 209.

The controller 208 of the golf navigation device 200 may be realized by a microcontroller, and incorporates the memory 207 capable of storing data processed by the microcontroller.

The communication part 202 includes an RF module and an antenna that are capable of communicating wirelessly with the outside world.

The power supply part 209 incorporates a battery, and may be charged by an external charger via the charging terminal 205.

The touch screen 201 is an input means that may be replaced by other input means if necessary, on which a desired menu option can be selected. For example, external communication with a smartphone or other functions may be selected.

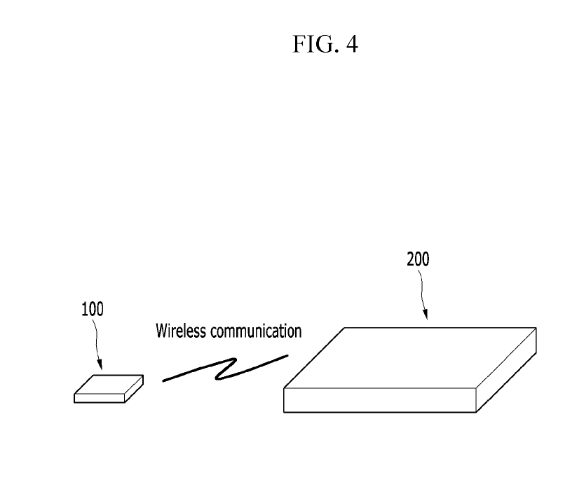

FIG. 4 shows that the golf navigation terminal 100 and the golf navigation device 200 send and receive data while communicating wirelessly with each other.

If necessary, the golf navigation device 200 may communicate with a plurality of golf navigation terminals 100 and create and transmit scores to each of the golf navigation terminals 100.

Hereinafter, an operation of creating a score and transmitting it between the golf navigation terminal 100 and the golf navigation device 200 will be described in detail.

First of all, a player has to wear the golf navigation terminal 100 on his or her waist. It can be worn on the waist in various ways. For example, the golf navigation terminal 100 may be attached and detached to and from a belt, or the golf navigation terminal 100 may be made as part of the buckle of a belt.

Various other methods can be used, including attaching a pocket to a belt to put the golf navigation terminal 100 in or take it out. These methods are generally well-known in the art, so detailed descriptions thereof will be omitted.

As the golf navigation terminal 100 is equipped with the GPS receiver 101, the player's position is calculated in real time. The player's position is communicated wirelessly to the golf navigation device 200 via the terminal communication part 107 under control of the terminal controller 118.

Then, the golf navigation device 200 displays the player's position on a digital electronic map of the golf course stored in the memory 207. When the player moves, the movement data is communicated in real time or periodically to the golf navigation device 200. The golf navigation device 200 calculates the distance he or she has moved, and at the same time displays the shift in the player's position on the map in real time or periodically.

The vibration sensor 102 of the golf navigation terminal 100 senses a vibration produced when the player moves or hits a ball with a club, the light sensor 103 senses a change in the amount of light caused by the player's hand movement, the magnetic sensor 104 senses movements of metal parts of the golf club used by the player, and the sound sensor 105 senses a sound produced when the player hits a golf ball or a sound produced when the golf ball rolls into a hole.

The terminal controller 118 calculates data about whether a stroke has been taken or not, using data detected by the motion detector 117 in the first place, and transmits it to the golf navigation device 200. If necessary, the terminal controller 118 transmits the detected data directly to the golf navigation device 200 for convenience of calculation.

Then, the golf navigation device 200 puts together the received detected data or stroke data, the digital electronic map of the golf course, etc., to calculate the number of strokes the player has taken, and transmits it wirelessly to the golf navigation terminal 100 via the communication part 202.

Then, the terminal controller 100 of the golf navigation terminal 100 displays a score received via the terminal communication part 107 on the display 111.

Next, the player checks if the score is correct, and if so, confirms it by pressing the data input confirmation button switch 113. Then, the terminal controller 118 sends score confirmation data to the golf navigation device 200 to fix the score. If the player proceeds to the next hole without pressing the data input confirmation button switch 113, the controller 208 of the golf navigation device 200 counts the score it has sent as correct and fixes the score.

On the other hand, if the score displayed on the display 111 of the golf navigation terminal 100 is wrong, the player operates the up button switch 114 or down button switch 115 of the display panel 106 to correct the score and presses the confirmation switch 113. In this case, the terminal controller 118 displays the corrected score on the display 111 to make it easy to correct it again.

The terminal controller 118 then sends the corrected score to the golf navigation device 200. The controller 208 of the golf navigation device 200 then corrects the score in the memory 207 to be the same as the corrected score, and sends the corrected score to the golf navigation terminal 100 for confirmation. If necessary, the score may include the number of strokes for the current hole and the cumulated number of strokes, or may include either of the two.

If necessary, in the golf navigation terminal 100, an algorithm capable of receiving signals sensed by the GPS receiver 101, the vibration sensor 102, the light sensor 103, the magnetic sensor 104, and the sound sensor 105 and determining ball impact may be used for the terminal controller 118 to calculate a score by detecting a ball's position, driving distance, whether the ball is hit or not, etc., in order to increase the accuracy of score calculations.

The calculated data is sent to the golf navigation device 200, and the golf navigation device 200 receives the data and checks the score by bringing it together with digital map data of the golf course in the golf navigation device 200.

Next, the checked score may be transmitted to the golf navigation terminal 100 and stored as a score after the player's confirmation.

If wireless communication between the golf navigation terminal 100 and the golf navigation device 200 does not work well due to a problem such as distance, the terminal controller 118 of the golf navigation terminal 100 stores calculated score data in its own memory 116, and sends the data stored in the memory 116 when it begins to communicate again with the golf navigation device 200.

Also, the golf navigation device 200 is equipped with the communication port 204 through which data in the golf navigation device 200 may be moved to a PC, smartphone, etc. Moreover, programs may be updated using the communication port 204, like updating the digital map of the golf course.

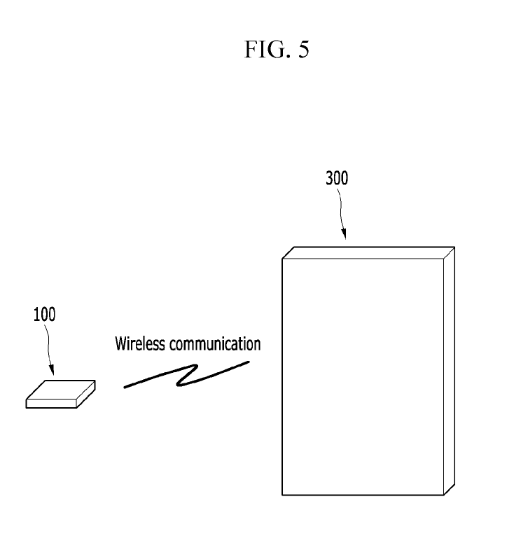

FIG. 5 shows that the golf navigation terminal 100 allows a player's score data to be viewed through a smartphone 300 by using an application installed on the smartphone 300, while communicating wirelessly with the smartphone 300.

If necessary, the golf navigation device 200 allows a player's score data to be viewed through the smartphone 300 by using an application installed on the smartphone 300, while communicating wirelessly with the smartphone 300.

As such, the golf navigation terminal 100 or the golf navigation device 200 may be very useful during a round since it can share data by interfacing with a smartphone.

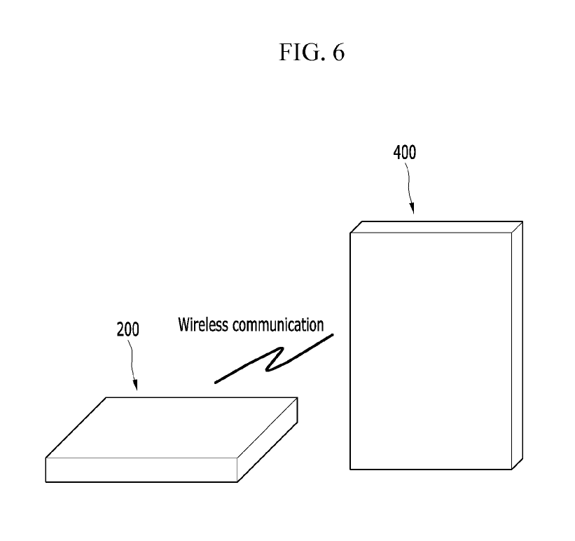

FIG. 6 is a view showing communication between the golf navigation device and a server according to an exemplary embodiment of the present invention.

Referring to FIG. 6, scores are transmitted from the golf navigation device 200 to a server 400, and the server 400 stores information about members around the world and 3D maps of golf courses in the world. As the server 400 is connected to a network including a mobile communication network or an internet network, a member may sign up to get real-time golf scores of at least one player during a golf game. In other words, a player or a viewer may connect to the server 400 and select a player they want to keep score for. Then, the server 400 may report scores while displaying a map of the golf course and each player's position on the screen of a smartphone or PC. Accordingly, the viewer can watch the game quite comfortably.

If necessary, a 3D map, rather than a simplified map, may be used so that the viewer can watch the game as if he or she were there.

In an exemplary embodiment of the present invention, players can enjoy playing golf as they can see their scores or others' scores in real time during a round.

If necessary, the golf navigation terminal 100 may perform all functions of the golf navigation device 200. That is, the golf navigation terminal 100 itself may create and provide golf scores. In this case, the terminal controller may receive an output from the motion detector, create a score based on data about a player's position, movement, and motion or about a golf ball's position and display the score on the display panel, and when the player enters confirmation data or corrected data, transmit the confirmation data or the corrected data to the golf navigation device.

In addition, the exemplary embodiments of the present invention may be modified in various ways and realized by the golf navigation terminal 100 alone, and allow for reporting of golf scores by interfacing with smartphones surrounding the golf navigation terminal 100.

The exemplary embodiments of the present invention are implemented not only through the apparatus and method, but may be implemented through a program that realizes functions corresponding to constituent members of the exemplary embodiments of the present invention or a recording medium in which the program is recorded. Such an implementation will be easily realized by those skilled in the art as described in the exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A golf navigation terminal which detects a movement of a player playing with a golf club and communicates with a golf navigation device, the golf navigation terminal comprising:
a display panel for receiving a user's selection or displaying data;
a motion detector for detecting data about the player's position, movement, and motion or about a golf ball's position;
a terminal communication part for communicating with the golf navigation device; and
a terminal controller that receives output from the motion detector and transmits the output to the golf navigation device via the terminal communication part, displays the player's score on the display panel upon receiving it from the golf navigation device, and when the player enters confirmation data or corrected data, transmits the confirmation data or the corrected data to the golf navigation device.

2. The golf navigation terminal of claim 1, wherein
the motion detector comprises at least one of:
a GPS receiver that receives a from a GPS satellite and calculates and outputs the GPS receiver's location;
a vibration sensor for sensing a vibration produced when the player moves or hits a golf ball with a golf club;
a light sensor for sensing a change in the amount of light caused by the player's hand movement;
a magnetic sensor for sensing movements of metal parts of the golf club used by the player; and
a sound sensor for sensing a sound produced when the player hits a golf ball ball or a sound produced when the golf ball is rolled into a hole.

3. The golf navigation terminal of claim 2, wherein the terminal controller receives output from the GPS receiver, the vibration sensor, the light sensor, the magnetic sensor, and the sound sensor and transmits the output to the golf navigation device via the terminal communication part, displays the player's score on the display panel upon receiving it from the golf navigation device, and when the player enters confirmation data or corrected data, transmits the confirmation data or the corrected data to the golf navigation device.

4. The golf navigation terminal of claim 3, wherein the display panel comprises:
a display for displaying data;
a menu button switch for selecting menu options;
a confirmation button switch for confirming data input;
an up button switch for raising the score one level; and
a down button switch for lowering the score one level.

5. The golf navigation terminal of claim 4, further comprising:
a power supply part for supplying power to the display panel, the terminal communication part, the controller, and the motion detector; and
a power switch for selecting whether to supply power or not.

6. The golf navigation terminal of claim 5, further comprising:
a memory for storing data received by the motion detector and the confirmation data or corrected data;
a communication port for transmitting and receiving data in the memory to and from the outside world; and
a charging terminal for charging the power supply part.

7. A golf navigation device which communicates with a golf navigation terminal, the golf navigation device comprising:
a touch screen for receiving a user's selection;
a display for displaying data;
a communication part for communicating with the golf navigation terminal; and
a controller that receives data about the player's position, movement, and motion or about a golf ball's position, creates a score corresponding to the received data and transmits the score to the golf navigation terminal via the communication part, and upon receiving confirmation data or a corrected score from the golf navigation terminal, displays the received confirmation data or corrected score on the display.

8. The golf navigation device of claim 7, wherein the controller creates a score when the player moves or hits a golf ball with a golf club or when the golf ball rolls into a hole.

9. The golf navigation device of claim 8, further comprising a memory for storing data,
wherein the controller cumulatively stores the score in the memory.

10. The golf navigation device of claim 9, further comprising:
a power supply part for supplying power to the touch screen, the display, the communication part, and the controller; and
a power switch for selecting whether to supply power or not.

11. The golf navigation device of claim 10, further comprising:
a communication port for transmitting and receiving data in the memory to and from the outside world; and
a charging terminal for charging the power supply part.

12. The golf navigation device of claim 11, wherein the memory additionally stores map data of the golf course, and the controller creates a score with additional reference to the map data of the golf course.

13. The golf navigation device of claim 7, wherein the controller transmits the score to a server that provides at least one viewer terminal with at least one player's scores and shows the viewer terminal how the game is played.

14. A golf navigation terminal which detects a movement of a player playing with a golf club and communicates with a golf navigation device, the golf navigation terminal comprising:
a display panel for receiving a user's selection or displaying data;
a motion detector for detecting data about the player's position, movement, and motion or about a golf ball's position;
a terminal communication part for communicating with the golf navigation device; and
a terminal controller that receives an output from the motion detector, creates a score based on data about the player's position, movement, and motion or about a golf ball's position and displays the score on the display panel, and when the player enters confirmation data or corrected data, transmits the confirmation data or the corrected data to the golf navigation device.
